(19) United States
(12) Patent Application Publication
(10) Pub. No.: US 2014/0205040 A1
(43) Pub. Date: Jul. 24, 2014

(54) System and Method for Digital Communications Using Channel Statistics

(71) Applicant: FutureWei Technologies, Inc., Plano, TX (US)

(72) Inventors: Meisam Razaviyayn, Minneapolis, MN (US); Zhi-Quan Luo, Maple Grove, MN (US); Mohammadhadi Baligh, Kanata (CA)

(21) Appl. No.: 14/163,692

(22) Filed: Jan. 24, 2014

Related U.S. Application Data
(60) Provisional application No. 61/756,325, filed on Jan. 24, 2013.

(51) Int. Cl. H04B 7/06

(52) U.S. Cl. CPC H04B 7/0617
USPC 375/295

(57) ABSTRACT

A method for operating a transmitting device includes designing a beamformer using a stochastic weighted minimum mean square error (SWMMSE) algorithm to optimize a utility function in accordance with channel statistics of communications channels in a communications system, adjusting a transmitter of the transmitting device in accordance with the beamformer, and transmitting to a user equipment using the adjusted transmitter.

This application claims the benefit of U.S. Provisional Application No. 61/756,325, filed on Jan. 24, 2013, entitled “System and Method for a Wireless Transceiver Design Using Channel Statistics,” which application is hereby incorporated herein by reference.

### TECHNICAL FIELD

The present disclosure relates generally to digital communications, and more particularly to a system and method for digital communications using channel statistics.

### BACKGROUND

Consider a multiple input multiple output (MIMO) interference channel consisting of K transmitter-receiver pairs, where different transmitters wish to simultaneously send independent data streams to their intended receivers. The MIMO interference channel can effectively model many different practical systems, such as digital subscriber lines (DSL), cognitive radio systems, ad-hoc wireless networks, wireless cellular communication, and the like.

### SUMMARY OF THE DISCLOSURE

Example embodiments of the present disclosure which provide a system and method for digital communications using channel statistics.

In accordance with an example embodiment of the present disclosure, a method for operating a transmitting device is provided. The method includes designing, by the transmitting device, a beamformer using a stochastic weighted minimum mean square error (SWMMSE) algorithm to optimize a utility function in accordance with channel statistics of communications channels in a communications system, and adjusting, by the transmitting device, a transmitter of the transmitting device in accordance with the beamformer. The method also includes transmitting, by the transmitting device, to a user equipment using the adjusted transmitter.

In accordance with an example embodiment of the present disclosure, a method for operating a device is provided. The method includes determining, by the device, channel estimates of a subset of communications channels in a communications system, deriving, by the device, statistical information of the communications channels in the communications system in accordance with the channel estimates, and storing, by the device, the statistical information in a memory.

In accordance with another example embodiment of the present disclosure, a transmitting device is provided. The transmitting device includes a processor, and a transmitter operatively coupled to the processor. The processor designs a beamformer using a stochastic weighted minimum mean square error (SWMMSE) algorithm to optimize a utility function in accordance with channel statistics of communications channels in a communications system, and adjusts a transmitter of the transmitting device in accordance with the beamformer. The transmitter transmits to a user equipment using the adjusted transmitter.

One advantage of an embodiment is that perfect and global knowledge of communications channel condition in a communications system is not required, therefore, the amount of overhead associated with determining perfect and global knowledge is not needed.

A further advantage of an embodiment is that channel statistics (or similarly, long term channel information) is used to provide tolerance to transient and/or short lived changes to communications channel condition.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2 illustrates an example system model according to example embodiments described herein;

FIGS. 3a and 3b illustrate example SWMMSE algorithms according to example embodiments described herein;

FIG. 4 illustrates a flow diagram of example operations occurring in a transmitting device as the transmitting device transmits according to example embodiments described herein;

FIG. 5 illustrates a flow diagram of example operations occurring in a transmitting device as it designs beamformers using a SWMMSE and channel statistics according to example embodiments described herein;

FIG. 6 illustrates a flow diagram of example operations occurring in a receiving device according to example embodiments described herein;

FIG. 7 illustrates a data plot of a comparison of simulated performance between SWMMSE and weighted minimization of MSE (WMMSE) algorithms for different values of γ according to example embodiments described herein; and

FIG. 8 illustrates an example communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to digital communications using channel statistics. For example, a transmitting device designs a beamformer using a stochastic weighted minimum mean square error (SWMMSE) algorithm to optimize a utility function in accordance with channel statistics of communications channels in a communications system, adjusts a transmitter of the transmitting device in accordance with the beamformer, and transmits to a user equipment using the adjusted transmitter.

The present disclosure will be described with respect to example embodiments in a specific context, namely communications systems that use channel statistics to facilitate advanced communications techniques. The disclosure may be applied to standards compliant communications systems, such as those that are compliant with Third Generation Partnership Project (3GPP), IEEE 802.11, and the like, technical standards, and non-standards compliant communications systems, that use channel statistics to facilitate advanced communications techniques.

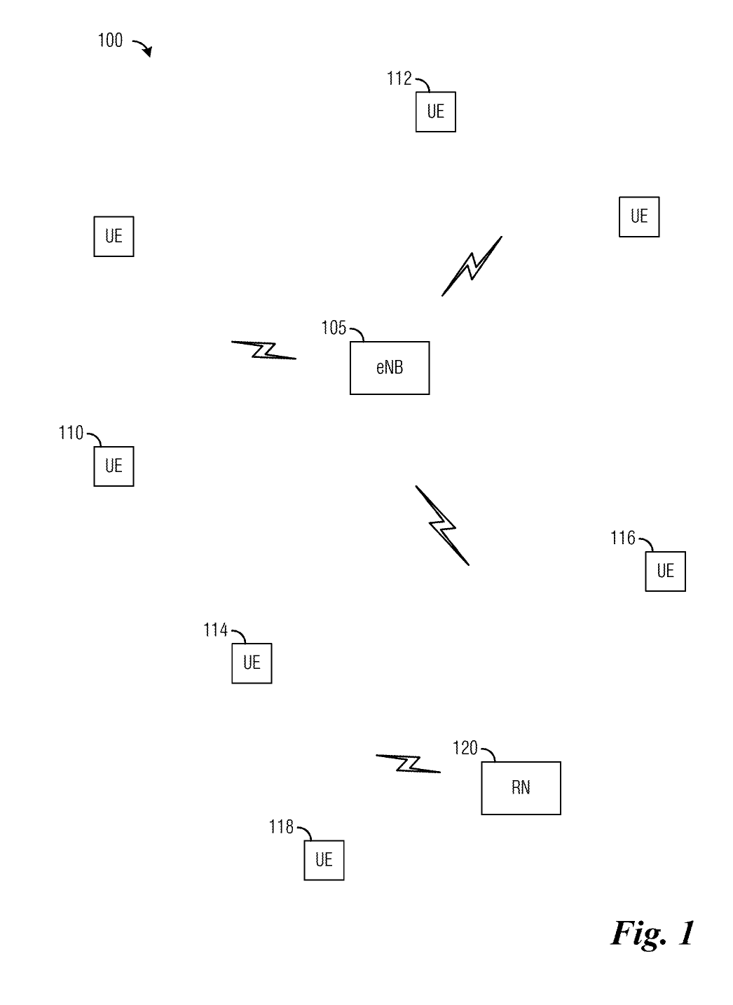

FIG. 1 illustrates an example communications system 100. Communications system 100 includes an evolved NodeB (eNB) 105, which may serve a plurality of user equipment (UE), such as UE 110, UE 112, UE 114, UE 116, and UE 118. eNBs may also be commonly referred to as controllers, communications controllers, base stations, NodeBs, base terminal stations, and the like, while UEs may also be commonly referred to as users, terminals, subscribers, mobile stations, mobiles, and the like. In a first configuration of communications system 100, eNB 105 may allocate network resources for communications to a UE, to multiple UEs simultaneously, or from a UE. In a second configuration of communications system 100, UEs may be able to directly communicate with one another without having allocated network resources from eNB 105.

Communications system 100 may also have a relay node (RN) 120. RN 120 may be used to help improve coverage in poor coverage areas and/or to increase overall performance. In general, an eNB may donate a portion of its network resources to a RN to achieve better coverage and/or increased performance. As shown in FIG. 1, RN 120 may serve UE 118 better than eNB 105 since it is closely located to UE 118.

A UE, such as UE 116, may also receive transmissions from multiple transmitting devices, such as eNB 105 and RN 120, to help improve its performance. As an illustrative example, UE 116 may receive a first transmission from eNB 105 and a second transmission from RN 120. The first transmission and the second transmission may be the same or they may be different.

While it is understood that communications systems may employ multiple eNBs and RNs capable of communicating with a number of UEs, only one eNB and one RN, and a number of UEs are illustrated for simplicity.

In MIMO, multiple transmit antennas and/or multiple receive antennas may be used to improve communications performance. As an example, a transmitting device may transmit to a receiving device using multiple transmit antennas. The receiving device may receive the multiple transmissions with one or more receive antennas. As another example, a transmitting device with two transmit antennas may simultaneously transmit to two different receiving devices with one transmit antenna each.

When multiple transmit antennas (commonly referred to as an antenna array) are used, a transmission may be precoded to help improve performance. Beamforming is an example of precoding where coefficients of an antenna array are adjusted so that a transmission pattern of the antenna array is reshaped to typically point towards the receiving device. A wide range of beamforming approaches have been proposed. As an example, beamforming techniques using noncooperative game methods or optimizing a utility of the communications system have been studied. However, the proposed beamforming techniques generally require perfect and global knowledge of channel state information (CSI), which may be impractical due to communications channel aging, as well as channel estimation errors. Furthermore, global CSI knowledge may incur a large amount of communications overhead due to the sharing of the CSI.

Additionally, the proposed beamforming techniques are usually designed to perform well in worse case scenarios, therefore, they may be suboptimal when the worse cases occur with small probability. According to an example embodiment, it may be possible to design a beamforming technique to perform well under average case scenarios that occur with high probability. The beamforming technique may utilize a stochastic optimization framework.

The following notations are adopted herein. The notation I stands for the identity matrix. Furthermore, Tr(·), det(·), E(·), (·)^{H}, and (·, ·) are used to denote trace, determinant, expectation, conjugate transpose, and inner product operator, respectively. The notation ∥·∥ denotes the Frobenius norm of a matrix.

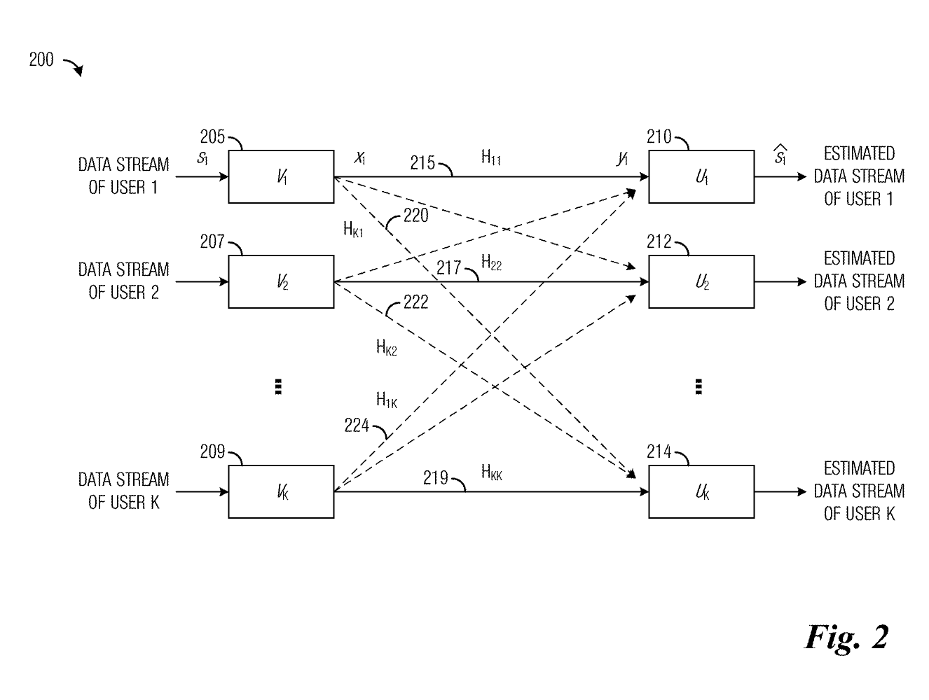

FIG. 2 illustrates an example system model 200. For discussion purposes, consider an interference channel consisting of K transmitter-receiver pairs, each equipped with multiple antennas. A transmitter from transmitter j to receiver k is shown in FIG. 2. A transmit precoder of user k is denoted Vₖ, and a receiver postcoder of user k is denoted Uₖ. As an example, transmit precoder V₁ 205, V₂ 207, and V_{K} 209 and receiver postcoder U₁ 210, U₂ 212, and U_{K} 214. A channel matrix H describes a communications channel between a transmitter-receiver pair. As an example, channel matrix H₁₁ describes channel 215, channel matrix H₂₂ describes channel 217, and channel matrix H_{KK} describes channel 219. Typically, a transmission between a transmitter-receiver pair will also result in interference at another receiver. System model 200 considers the interference as interfering channels. As an example, channel matrix H_{K1} describes interference seen at receive postcoder U_{K} 214 from transmit precoder V₁ 205 over interfering channel 220. Similarly, channel matrix H_{K2} describes interference seen at receive postcoder U_{K} 214 from transmit precoder V₂ 207 over interfering channel 222 and channel matrix H_{1K} describes interference seen at receive postcoder U₁ 210 from transmit precoder V_{K} 209 over interfering channel 224.

Define

$$K {=}^{Δ} \{ 1 , 2 , … , K \}$$

to be the set of all users. Assume each transmitter kεK is equipped with Mₖ antennas and sends dₖ data streams to receiver k equipped with Nₖ number of antennas. Let HₖⱼεC^{Nk×Mj} denote the channel matrix from transmitter j to receiver k. To keep the decoding and encoding process simple, a linear beamforming strategy is considered in which the transmit signal of user k is given by xₖ=Vₖsₖ, where VₖεC^{Mk×dk} and sₖεC^{dk×1} are the transmit beamformer and the data stream of user k, respectively. Under these assumptions, the received signal of user k can be expressed as

$${y}_{k} = \underbrace{{H}_{kk} {x}_{k}}_{desired signal} + \underbrace{{\sum }_{j = 1 , j \neq k}^{K} {H}_{kj} {x}_{j} + {n}_{k}}_{interference plus noise} ,$$

where nₖεC^{Nk×1} denotes the additive white Gaussian noise with distribution CN(0,σₖ²I). Moreover, a linear reception strategy is considered, i.e., ŝₖ=Uₖ^{H}yₖ, where ŝₖεC^{dk×1} and UₖεC^{Nk×dk} are the estimated data stream and the receive beamformer of user k, respectively. Assuming normalized power data streams with E[sₖsₖ^{H}]=I, the instantaneous achievable rate of user k can be expressed as

$${R}_{k}^{inst} = log det ( I + {H}_{kk} {V}_{k} {V}_{k}^{H} {H}_{kk}^{H} \times {( {σ}_{k}^{2} I + {\sum }_{j \neq k}^{ } {H}_{kj} {V}_{j} {V}_{j}^{H} {H}_{kj}^{H} )}^{- 1} ) .$$

When the channels are experiencing fast fading or the exact channel knowledge is not available, the channel matrices {Hₖⱼ}k,jεK can be modeled as random variables. Hence the average and/or ergodic achievable rate of user k is given by Rₖ=E(Rₖ^{inst}) where the expectation is taken over the distribution of the channels. Exact and complete channel knowledge generally is not available due to communication overhead, channel aging, channel estimation errors.

A commonly used utility maximization problem is the weighted sum rate maximization problem which can be expressed as

$${max}_{V} {\sum }_{k = 1}^{K} 𝔼 [ {R}_{k}^{inst} ] \\ \begin{matrix}s . t . \\ Tr ( {V}_{k} {V}_{k}^{H} ) \leq {P}_{k} , \\ ∀ k ∈ 𝒦 , & □\end{matrix} \qquad ( P )$$

where Pₖ is the power budget of user k and

$$V {=}^{Δ} \{ {V}_{k} \vert k ∈ K \} .$$

It is noted that although the weighted sum rate utility function is discussed, other utility functions, such as a harmonic mean utility function, a proportional fairness utility function, and the like, may be used in its place.

Viewed slightly differently, a stochastic/ergodic sum rate maximization is expressible as

where

$${max}_{V} 𝔼 [ {\sum }_{k = 1}^{K} log det ( I + {H}_{kk} {V}_{k} {V}_{k}^{H} {{H}_{kk}^{H} ( {NPI}_{k} )}^{- 1} ) ] , \\ s . t . \\ Tr ( {V}_{k} {V}_{k}^{H} ) \leq {p}_{k} , ∀ k$$

$${NPI}_{k} {=}^{△} {σ}_{k}^{2} I + {\sum }_{j \neq k}^{ } {H}_{kj} {V}_{j} {V}_{j}^{H} {H}_{kj}^{H} .$$

The stochastic non-convex optimization problem (P) appears to be very challenging to solve. In fact, even the deterministic version of this problem is known to be NP-hard. An example embodiment provides an efficient polynomial time algorithm for approximately solving (P). The following lemma helps reformulate (P) into a more computationally attractive problem.

Lemma 1: Define

$${E}_{k} ( {U}_{k} , V , H ) {=}^{△} ( I - {U}_{k}^{H} {H}_{kk} {V}_{k} ) {( I - {U}_{k}^{H} {H}_{kk} {V}_{k} )}^{H} + {\sum }_{j \neq k}^{ } {U}_{k}^{H} {H}_{kj} {V}_{j} {V}_{j}^{H} {H}_{kj}^{H} {U}_{k} + {σ}_{k}^{2} {U}_{k}^{H} {U}_{k} .$$

Then,

$$( {U}_{k}^{*} , {W}_{k}^{*} , {Z}_{k}^{*} ) = arg {max}_{{U}_{k} , {W}_{k} , {Z}_{k}} log det ( {W}_{k} ) - Tr ( {W}_{k} {E}_{k} ( {U}_{k} , V , H ) ) - β {‖ {Z}_{k} - {V}_{k} ‖}^{2} , \qquad ( 2 )$$

where β is a positive scalar, Uₖ* is the MMSE receiver, i.e.,

$${U}_{k}^{*} = ( {\sum }_{j = 1}^{K} {H}_{kj} {V}_{j} {V}_{j}^{H} {H}_{kj}^{H} + {σ}_{k}^{2} I ) {H}_{kk} {V}_{k} ;$$

Wₖ*=(Eₖ(Uₖ*, V, H))⁻¹, and Zₖ*=Vₖ. Moreover, the optimum objective value in (2) is equal to Rₖ^{inst} in (1).

Lemma 1 may be used to reformulate problem (P) into the following equivalent optimization problem:

$${min}_{V} 𝔼 [ {min}_{U , W , Z} {\sum }_{k = 1}^{K} - log det {W}_{k} + Tr ( {W}_{k} {E}_{k} ) + β {‖ {V}_{k} - {Z}_{k} ‖}^{2} ] \\ s . t . \\ Tr ( {V}_{k} {V}_{k}^{H} ) \leq {P}_{k} , ∀ k ∈ 𝒦 \qquad ( Q )$$

where, for the notational simplicity, Eₖ(Uₖ, V, H) is denoted by Eₖ. In addition, the definitions

$$U {=}^{Δ} \{ {U}_{k} \vert k ∈ K \} , \begin{matrix}W {=}^{Δ} \{ {W}_{k} \vert k ∈ K \} , & Z {=}^{Δ} \{ {Z}_{k} \vert k ∈ K \}\end{matrix}$$

are used.

From the formulation (Q), it can be observed that the optimization variables U, W, and Z may be optimized for instantaneous channel realizations, while the transmit beamformer V is optimized after considering the expectation effect. Using this observation, an example embodiment updates the variables U, W and Z based on (2), and updates the variable V by taking the ensemble average of the objective function in (Q). More specifically, after observing a channel realization

$${H}^{r} {=}^{Δ} \{ {H}_{kj}^{r} \vert k , j ∈ K \}$$

at iteration r, the auxiliary variables U, W, and Z may be updated by

$$( {U}^{r} , {W}^{r} , {Z}^{r} ) = arg {min}_{U , W , Z} {\sum }_{k = 1}^{K} [ - log det ( {W}_{k} ) + Tr ( {W}_{k} {E}_{k} ( {U}_{k} , {V}^{r - 1} , {H}^{r} ) ) + β {‖ {Z}_{k} - {V}_{k} ‖}^{2} ] . \qquad ( 3 )$$

and update the transmit beamformer V by

$${V}^{r} = arg {min}_{V} \frac{1}{r} {\sum }_{i = 1}^{r} {\sum }_{k = 1}^{K} [ Tr ( {W}_{k}^{i} {E}_{k} ( {U}_{k}^{i} , V , {H}^{i} ) ) + β {‖ {Z}_{k}^{i} - {V}_{k} ‖}^{2} ] \\ s . t . Tr ( {V}_{k} {V}_{k}^{H} ) \leq {P}_{k} , ∀ k ∈ 𝒦 . \qquad ( 4 )$$

It is noted that H^{r} may be determined from actual CSI and/or generated virtually using known channel statistics.

Utilizing Lagrange multipliers μₖ for the k-th user power budget constraint, the solution of (4) is expressible as

Vₖ^{r}=(Aₖ^{r}+μₖ*I)⁻¹Bₖ^{r}, (5)

where

$${A}_{k}^{r} {=}^{Δ} {\sum }_{i = 1}^{r} ( β 1 + {\sum }_{j = 1}^{K} {( {H}_{jk}^{i} )}^{H} {U}_{j}^{i} {{W}_{j}^{i} ( {U}_{j}^{i} )}^{H} {H}_{jk}^{i} ) , \\ {B}_{k}^{r} {=}^{Δ} {\sum }_{i = 1}^{r} ( β {Z}_{k}^{i} + {( {H}_{kk}^{i} )}^{H} {U}_{k}^{i} {W}_{k}^{i} ) ,$$

and μₖ* is the optimal Lagrange multiplier, which can be obtained by one dimensional search algorithms (e.g., bisection), so that the power budget constraints are satisfied. It is noted that Aₖ and Bₖ may be referred to as channel statistics, or equivalently long term channel information. Channel statistics typically provide an extended view of the condition of the communications channels, such as an average of the condition of the communications channel, and provides a degree of insulation from transient changes in the condition.

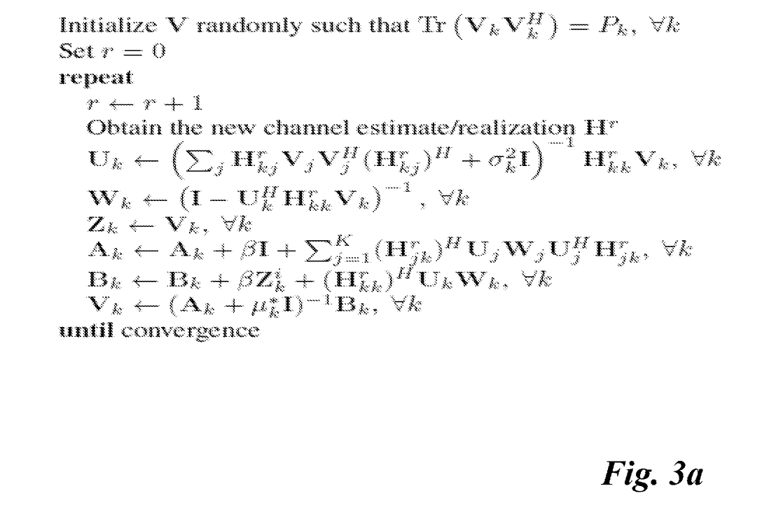

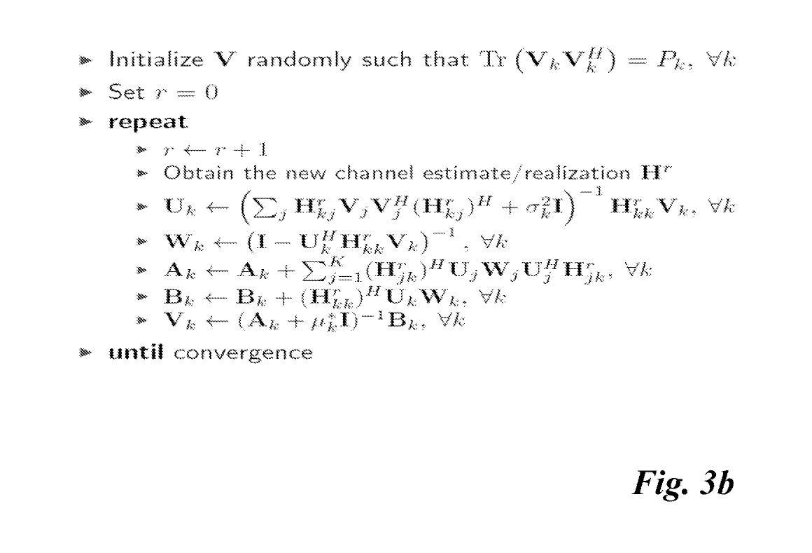

A first example embodiment of stochastic weighted minimization of MSE (SWMMSE) algorithm is summarized in FIG. 3a, where Uₖ is a receiver postcoder for receiver k, Vₖ is a transmitter precoder for transmitter k, Wₖ is a weighting matrix of user k that relates a sum utility maximization to a sum mean square error (MSE) minimization, Aₖ and Bₖ are statistical information for a reciprocal communications channel, Hₖ is a channel matrix for a communications channel of user k, and σₖ is a noise distribution of a communications channel of user k. FIG. 3b illustrates a second example embodiment of the SWMMSE algorithm.

It is noted that the example embodiments shown in FIGS. 3a and 3b correspond to the use of a sum rate utility maximization utility function, the example embodiments may be modified to use other utility functions by changing the update rule for the weighting matrix Wₖ. Examples of other utility functions include harmonic mean utility functions, proportional fairness utility functions, and the like.

It is noted that although equation (4) states that the update rule of the transmit beamformers depends on all of the past channel realizations, The algorithm of FIG. 3a shows that all the required information could be encoded into two matrices Aₖ and Bₖ only. Therefore, there is no need to store all the previous channel realizations in the network. It is also worth noting that the algorithm generalizes to other utility functions and other system models.

With respect to an example embodiment, first, there are at least two different possible ways of implementing the SWMMSE algorithm. One way is to use the statistical knowledge of the channels to generate virtual realizations of the channels. Virtual CSI can be generated by the statistical knowledge of the channels for some channels (e.g., crosstalk links). Using the virtual realizations, one can optimize the beamformers in the SWMMSE algorithm. Another way estimates the channel coefficients at each iteration to update the beamformers. At iteration r of an embodiment algorithm, the estimated channels value Hr can be used. That is, Actual CSI can be estimated for the other channels (e.g., direct links).

Second, in practice, the channel statistics can vary over time. In order to consider this variation, one can add a forgetting factor λ, 0<λ<1, to the update rule of Aₖ and Bₖ in the algorithm. More precisely, the following update rules of Aₖ and Bₖ can be utilized in the SWMMSE algorithm:

$${A}_{k} ← λ {A}_{k} + β I + {\sum }_{j = 1}^{K} {( {H}_{jk}^{r} )}^{H} {U}_{j} {W}_{j} {U}_{j}^{H} {H}_{jk}^{r} , ∀ k$$

$${B}_{k} ← λ {B}_{k} + β {Z}_{k}^{i} + {( {H}_{kk}^{r} )}^{H} {U}_{k} {W}_{k} , ∀ k$$

Third, the role of the optimization variable Z is to make the objective function in (4) strongly convex. As described below, the strong convexity of the objective function helps establish a theoretical convergence guarantee for the embodiment algorithm.

The following theorem guarantees the convergence of the example embodiment algorithms.

Theorem 1: Assume bounded independent and identically distributed channel realizations over time. Furthermore, suppose that noise power is strictly positive, or σₖ²>0, ∀k εK. Then the iterates generated by the SWMMSE algorithm converge to the set of stationary points of the ergodic weighted sum rate maximization problem (P), i.e.,

$${lim}_{r -> ∞} d ( {V}^{r} , 𝕍 ) = 0 ,$$

where [symbol] is the set of stationary points of (P) and

$$d ( V , 𝕍 ) {=}^{Δ} inf {v}^{′} ∈ v ‖ V - {𝕍}^{′} ‖ .$$

It is worth noting that as an immediate consequence of bounded convergence theorem, the objective function in (P) is differentiable and ∇vE [Σₖ₌₁^{K} Rₖ(V)]= [symbol] [∇vΣₖ₌₁^{K} Rₖ(V)]. Hence, the set V is well-defined.

To formally prove Theorem 1, the following definitions are needed. Let us define

$$p {=}^{Δ} ( U , W , Z ) and g ( V , p , H ) {=}^{Δ} {\sum }_{k = 1}^{K} ( - log det {W}_{k} + Tr ( {W}_{k} {E}_{k} ( {U}_{k} , V , H ) ) + β {‖ {Z}_{k} - {V}_{k } ‖}^{2} ) .$$

Let us further define

$$f ( V ) {=}^{Δ} 𝔼 [ {min}_{p} g ( V , p , H ) ] , {\hat{f}}^{r} ( V ) {=}^{Δ} \frac{1}{r} {\sum }_{i = 1}^{r} g ( V , {p}^{i} , {H}^{i} ) , and {f}^{r} ( V ) {=}^{Δ} \frac{1}{r} {\sum }_{i = 1}^{r} {min}_{p} g ( V , p , {H}^{i} ) ,$$

where the expectation is taken over the channel distribution and pi [symbol] (Ui, Wi, Zi) is the value of the variables at iteration i.

Using the above definitions, the main steps of the SWMMSE algorithm is in fact alternating between the following two steps:

p^{r}←arg minₚg(V^{r-1},p,H^{r}),

V^{r}←arg minᵥ\ddot{f}^{r}(V),

where the superscript r is the iteration number index.

For a sketch of the Proof of Theorem 1, since the iterates {V^{r}} lie in a compact set

$$V {=}^{△} \{ V \vert Tr ( {V}_{k} {V}_{k}^{H} ) \leq {P}_{k} \} ,$$

it suffices to show that every limit point of the iterates is a stationary point of (P). Consider a subsequence {V^{rj}} converging to a limit point V̅. First of all, since σₖ²>0 and the channels are bounded, it is straightforward to show that the sequence p^{r} is bounded. Consequently, the functions {\hat{f}^{rj}(V)}ᵣ₌₁^{∞} are bounded and smooth defined over a compact set V and therefore, the family of functions {\hat{f}^{rj}(V)}ⱼ₌₁^{∞} is equi-continuous over V. Similarly, it can be argued that the family of functions {∇\hat{f}^{rj}(V)}ⱼ₌₁^{∞} is equi-continuous. Hence, by restricting to a subsequence, there exists a differentiable function \hat{f}^{∞}(V) so that

$${lim}_{j \to ∞} {\hat{f}}^{{r}_{j}} ( V ) = {\hat{f}}^{∞} ( V ) , ∀ V ∈ V . \qquad ( 6 )$$

On the other hand, since f^{r}(V) is bounded, for any fixed VεV, it can be shown that

$${lim}_{j \to ∞} {f}^{r} ( V ) = f ( V ) , almost surely , \qquad ( 7 )$$

by strong law of large numbers. Furthermore, it follows from the definition of \hat{f}^{r}(V) and f^{r}(V) that \hat{f}^{r}(V)≧f^{r}(V), ∀V, ∀r, and therefore, by combining with (6) and (7), it is obtained that

\hat{f}^{∞}(V)≧f(V),∀V. (8)

The equi-continuity of {\hat{f}^{r}(V)}ᵣ₌₁^{∞} and {f^{r}(V)}ᵣ₌₁^{∞} implies

$$\begin{matrix}{lim}_{j \to ∞} {f}^{{r}_{j}} ( {V}^{{r}_{j}} ) = f ( \overline{V} ) & ( 9 ) \\ {lim}_{j \to ∞} {\hat{f}}^{{r}_{j}} ( {V}^{{r}_{j}} ) = {\hat{f}}^{∞} ( \overline{V} ) . & ( 10 )\end{matrix}$$

On the other hand, using the strong convexity of \hat{f}^{r}(V), it can be shown that:
Claim: limr→∞\hat{f}^{r}(V)−f^{r}(V^{r})=0, almost surely.

Combining the result of the above claim with (9) and (10) yields

\hat{f}^{∞}( V̅)=f( V̅). (11)

In addition, \hat{f}^{r}(V^{r})≦\hat{f}^{r}(V), ∀VεV due to transmit beamformer update rule in the algorithm. Consequently, by letting r→∞, \hat{f}^{∞}( V̅)≦\hat{f}^{∞}(V), ∀VεV is obtained, or equivalently

[symbol]

∇\hat{f}^{∞}(\hat{V}),V− V̅ [symbol] ≧0,∀Vε [symbol] . (12)

It is noted that using the Taylor expansion of \hat{f}^{∞}(·) and f(·), the above may be re-written as

f^{∞}(V)=f^{∞}(\ddot{V})+(∇f^{∞}( V̅),V− V̅)+o(∥V− V̅∥²),

f(V)=f( V̅)+(∇f( V̅),V− V̅)+o(∥V−\ddot{V}∥²).

Subtracting the second equation from the first one, by using (8), (11), and ignoring the second order terms, <∇\hat{f}^{∞}( V̅)−∇f( V̅), V− V̅>≧0, ∀V may be obtained. Since this inequality holds for all possible choices of V, it is expressible as

∇f^{∞}( V̅)=∇f( V̅). (13)

Combining (12) and (13) yields

<∇f( V̅),V− V̅>≧0,∀Vε [symbol] ,

that is, V̅ is a stationary point of (P).

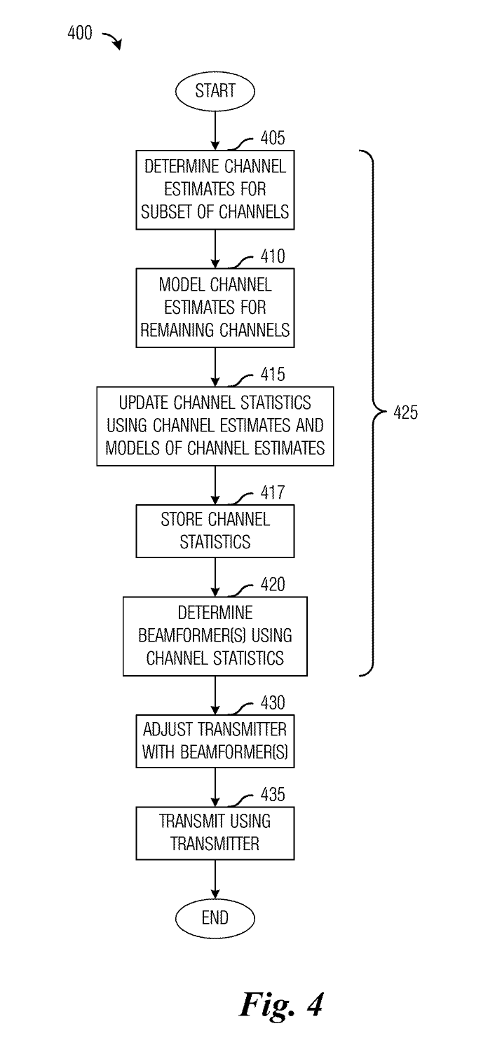

FIG. 4 illustrates a flow diagram of example operations 400 occurring in a transmitting device as the transmitting device transmits. Operations 400 may be indicative of operations occurring in a transmitting device, such as an eNB or a UE, as the transmitting device transmits to a receiving device, such as a UE or an eNB, using beamforming and channel statistics.

Operations 400 may begin with the transmitting device determining channel estimates for a subset of communications channels in the communications system (block 405). Typically, the transmitting device may be able to obtain channel estimates through a variety of techniques. A first technique may involve the transmitting device receiving the channel estimates, such as channel state information (CSI), reference signal received power (RSRP) report, channel parameters, and the like, from the receiving device. The transmitting device may transmit a reference signal, a pilot sequence, and the like, to help the receiving device make measurements of the communications channel to determine the channel estimates. A second technique may involve the use of channel reciprocity, where the transmitting device may make measurements of a reciprocal communications channel from the receiving device to the transmitting device and use the measurements to estimate the communications channel from the transmitting device to the receiving device. In many situations, such as in a time division duplexed (TDD) communications system or in a frequency division duplexed (FDD) communications system with communications channels that are close together in frequency, the transmitting device may be able to obtain channel estimates that are close to actual channel conditions using channel reciprocity.

As discussed previously, since a transmitting device typically does not utilize all of the communications channels in the communications system, it may not be necessary for the transmitting device to have global knowledge of all of the communications channels. As an illustrative example, an eNB may not need to know the channel condition of communications channels of other eNBs that are not its neighbor eNBs because they are likely to be so far away that transmissions occurring on the communications channels will not have any impact on transmissions made by the eNB. Therefore, determining channel estimates for a subset of the communications channels in the communications system that are close or relatively close to the transmitting device may help to reduce the communications overhead required to provide such information.

The transmitting device may model channel estimates for the communications channels that it did not directly determine channel estimates, i.e., the communications channels that are not in the subset of communications channels of block 405 (block 410). As an example, these channels could be modeled using outdated information from the past estimates and/or path loss information. The modeling could be done using any statistical channel models such as Rayleigh fading, Rician fading, and the like.

According to an example embodiment, the frequency in which the transmitting device determines the channel estimates for the subset of communications channel and models channel estimates for the communications channels that it directly determine channel estimates may be the same. According to another example embodiment, the frequency may be different. As an illustrative example, the determining of the channel estimates may occur more frequently than the modeling of the channel estimates.

The transmitting device may update the channel statistics for the communications channels using the channel estimates (block 415). The transmitting device may use the channel estimates that it determined (e.g., through reports or by direct measurement) as well as the modeled channel estimates to update the channel statistics, which may also be referred to as statistical information. As an illustrative example, the transmitting device may maintain an average of the channel estimates for the communications channels. In order to reduce the effect of older channel estimates, the transmitting device may apply a windowing technique where it discards channel estimates that are older than a specified age, the transmitting device may apply an aging factor or a forgetting factor to the channel estimates, and the like. The transmitting device may store the channel statistics in a memory, a remote database, and the like (block 417). Another device may use the channel statistics or the transmitting device may retrieve the channel statistics at a later time. It is noted that up to block 417, a device that is not transmitting may perform the collection of the channel statistics.

The transmitting device may use the channel statistics to determine beamformers (block 420). The transmitting device may use the channel statistics to determine the beamformers used to transmit to receiving devices. As an example, the transmitting device may use a SWMMSE algorithm, such as one shown in FIG. 3a or 3b to determine the beamformers. Collectively, blocks 405 through 420 may be referred to as designing beamformers using a SWMMSE algorithm to optimize a utility function in accordance with channel statistics (blocks 425).

The transmitting device may use the beamformers to adjust its transmitters (block 430) and use the transmitters to transmit (block 435).

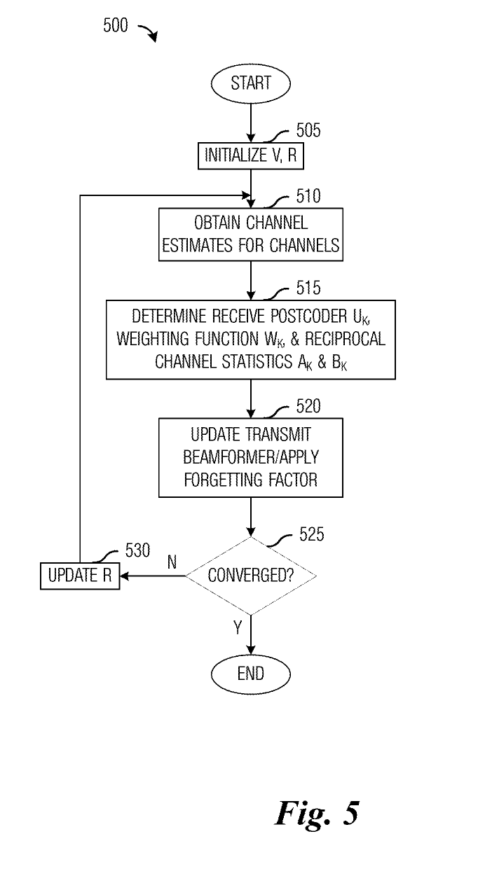

FIG. 5 illustrates a flow diagram of example operations 500 occurring in a transmitting device as it designs beamformers using a SWMMSE and channel statistics. Operations 500 may be indicative of operations occurring in a transmitting device, such as an eNB or a UE, as the transmitting device designs beamformers using a SWMMSE and channel statistics.

Operations 500 may begin with the transmitting device initializing variables (block 505). The transmitting device may initialize a beamformer. The transmitting device may initialize the beamformer to a default value, which may be provided by the operator of the communications system, a technical standard, and the like. Alternatively, the transmitting device may initialize the beamformer to a value so that the following is met:

Tr(VₖVₖ^{H})=Pₖ,

where Vₖ is a current beamformer for user k, and Pₖ is a power budget for user k.
As an example, the transmitting device may initialize a counter variable r that is used to keep track of a number of iterations, for purposes of algorithm convergence testing, for example.

The transmitting device may obtain channel estimates for communications channels (block 510). As discussed previously, the transmitting device may obtain channel estimates via feedback from other devices in the communications system or by making measurements of reciprocal communications channels. Additionally, the transmitting device may not need to obtain channel estimates of all communications channels in the communications system since many of them have no impact on transmissions made by the transmitting device. Therefore, the transmitting device may need to obtain channel estimates for a subset of communications channels in the communications system and model channel estimates for the remaining communications channels.

The transmitting device may determine a receive postcoder Uₖ and weighting function Wₖ, as well as reciprocal channel statistics Aₖ and Bₖ (block 515). According to an example embodiment, the receive postcoder Uₖ, the weighting function Wₖ, and the reciprocal channel statistics Aₖ and Bₖ may be expressed as:

Uₖ←(ΣⱼHₖⱼ^{r}VⱼVⱼ^{H}(Hₖⱼ^{r})^{H}+σₖ²I)⁻¹Hₖₖ^{r}Vₖ,∀k;

Wₖ←(I−Uₖ^{H}Hₖₖ^{r}Vₖ)⁻¹Hₖₖ^{r}Vₖ,∀k;

Aₖ←Aₖ+Σⱼ₌₁^{K}(Hⱼₖ^{r})^{H}UⱼVⱼUⱼ^{H}Hⱼₖ^{r},∀k; and

Bₖ←Bₖ+(Hₖₖ^{r})^{H}UₖWₖ,∀k,

where Hₖ is a channel matrix for a communications channel of user k, and σₖ is a noise distribution of a communications channel of user k. The updating of the Uₖ, Wₖ, Aₖ, and Bₖ may be performed synchronously or asynchronously.

The transmitting device may also apply a forgetting factor to reduce the impact of older channel estimates (block 520). In order to consider this variation, one can add a forgetting factor λ, 0<λ<1, to the update rule of Aₖ and Bₖ in the algorithm. More precisely, the following revised update rules of Aₖ and Bₖ can be utilized in the SWMMSE algorithm:

$${A}_{k} ← λ {A}_{k} + β I + {\sum }_{j = 1}^{K} {( {H}_{jk}^{r} )}^{H} {U}_{j} {W}_{j} {U}_{j}^{H} {H}_{jk}^{r} , ∀ k$$

$${B}_{k} ← λ {B}_{k} + β {Z}_{k}^{i} + {( {H}_{kk}^{r} )}^{H} {U}_{k} {W}_{k} , ∀ k$$

The transmitting device may also make the utility function more strongly convex through the use of optimization variable Z.

The transmitting device may perform a check to determine if the algorithm has converged (block 525). As an example, the transmitting device may check to determine if a requisite number of iterations have occurred. As another example, the transmitting device may check a gradient of a system utility and if it meets a threshold, the algorithm has converged. As yet another example, the transmitting device may check a system utility to determine if it is changing at a rate that meets a threshold and if it does, then the algorithm has converged. If the algorithm has not converged, the transmitting device may increment the variable r (block 530) and return to block 510 to repeat another iteration of the algorithm. If the algorithm has converged, the transmitting device may save the beamformers for subsequent use and operations 500 may terminate. According to an example embodiment, it may be possible to perform operations 500 in a periodic, continuous, or semi-continuous manner. In such a situation, as the operating environment changes, the beamformers may also be adjusted to keep track of the changing operating environment.

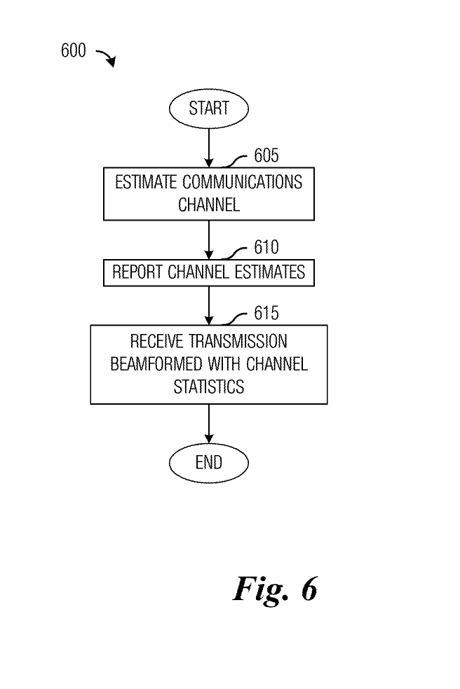

FIG. 6 illustrates a flow diagram of example operations 600 occurring in a receiving device. Operations 600 may be indicative of operations occurring in a receiving device, such as a UE or an eNB.

Operations 600 may begin with the receiving device estimating communications channels (block 605). The receiving device may estimate communications channels by measuring signals transmitted by a transmitting device and using the measured signals to determine the estimates of the communications channels. The receiving device may report the estimates to the transmitting device (block 610). The receiving device may report the estimates of the communications channels, changes in estimates of the communications channels, and the like, to the transmitting device and let the receiving device update the channel statistics. If the estimates have not changed sufficiently, the receiving device may not transmit the estimates, or it may transmit an indicator that the estimates have not changed sufficiently to warrant a report of the estimates. The receiving device may receive a transmission from the receiving device that has beamformed using the channel statistics derived from the estimates reported by the receiving device (block 615).

As an alternative, the receiving device may update channel statistics from the estimates and report the channel statistics to the transmitting device. The receiving device may quantize the channel statistics to reduce the amount of information being reported. The receiving device may report the channel statistics if the channel statistics have changed sufficiently, i.e., the change in the channel statistics exceed a specified value. If the channel statistics have not changed, the receiving device may not report the channel statistics or it may transmit an indicator that the channel statistics have not changed sufficiently to warrant a report of the channel statistics.

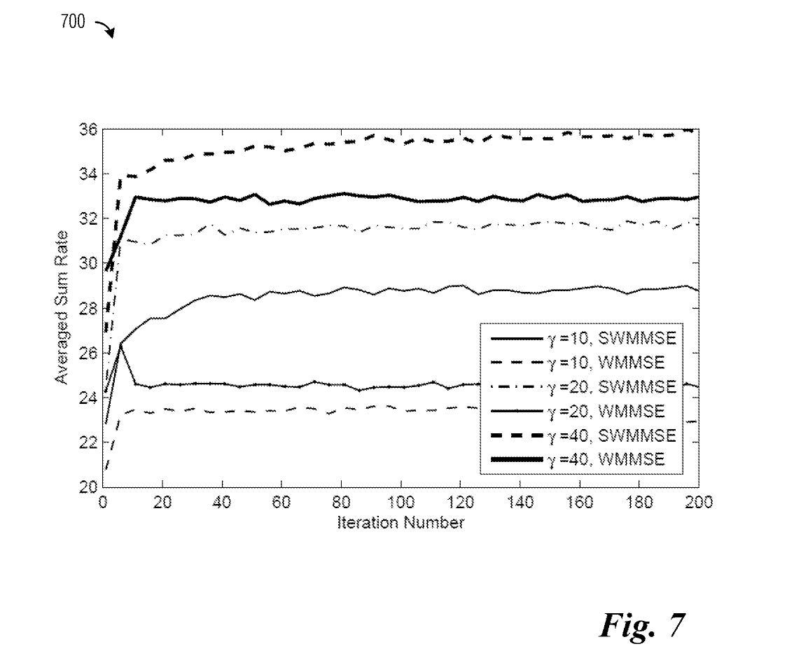

FIG. 7 illustrates a data plot 700 of a comparison of simulated performance between SWMMSE and weighted minimization of MSE (WMMSE) algorithms for different values of γ. The simulations used the value of β is set to 10⁻²⁰, and a forgetting factor of λ=0.98 is used to improve the convergence rate. Moreover, to calculate the ergodic sum rate or the expected value of the objective function, results are averaged over 1000 Monte Carlo runs. As can be seen from FIG. 7, the SWMMSE algorithm outperforms the WMMSE algorithm in every simulation.

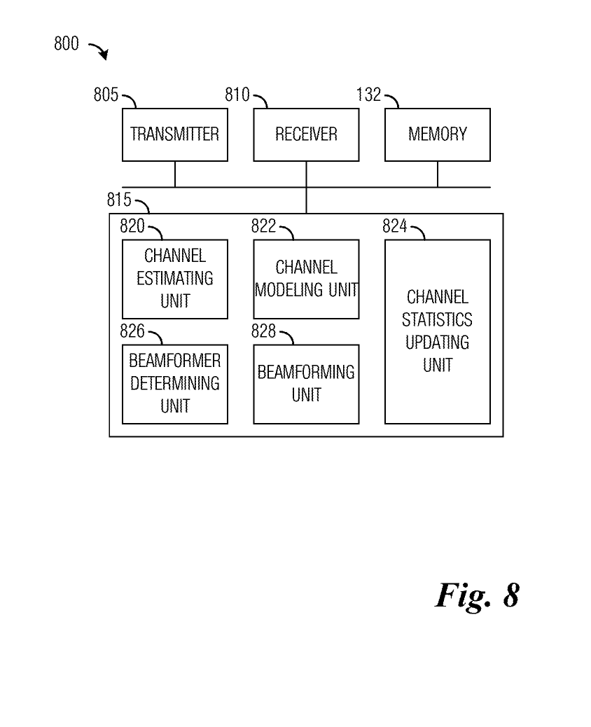

FIG. 8 illustrates an example communications device 800. Communications device 800 may be an implementation of a transmitting device, such as an eNB in a downlink transmission or a UE in an uplink transmission, a device collecting channel statistics or statistical information, and the like. Communications device 800 may be used to implement various ones of the embodiments discussed herein. As shown in FIG. 8, a transmitter 805 is configured to transmit packets, reference signals, pilots, and the like. Communications device 800 also includes a receiver 810 that is configured to receive packets, feedback, channel state information, and the like.

A channel estimating unit 820 is configured to estimate a communications channel using transmissions carried on the communications channel. The transmissions may include reference signals. A channel modeling unit 822 is configured to model a communications channel using channel statistics for the communications channel, for example. A channel statistics updating unit 824 is configured to update channel statistics for a communications channel in accordance with estimates of the communications channel and/or models of the communications channel. A beamformer determining unit 826 is configured to design a beamformer using a SWMMSE algorithm to optimize a utility function in accordance with channel statistics of communications channels. A beamforming unit 828 is configured to adjust a transmitter using a beamformer designed by beamformer determining unit 826. A memory 830 is configured to store estimates, reference signals, pilots, models, channel statistics, beamformers, packets, and the like.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while channel estimating unit 820, channel modeling unit 822, channel statistics updating unit 824, beamformer determining unit 826, and beamforming unit 828 may be software modules executing in a microprocessor (such as processor 815) or a custom circuit or a custom compiled logic array of a field programmable logic array. Channel estimating unit 820, channel modeling unit 822, channel statistics updating unit 824, beamformer determining unit 826, and beamforming unit 828 may be modules stored in memory 830.

Although the present disclosure and its advantages have been described in detail, it should be understood that various changes, substitutions and alterations can be made herein without departing from the spirit and scope of the disclosure as defined by the appended claims.

What is claimed is:

1. A method for operating a transmitting device, the method comprising:
designing, by the transmitting device, a beamformer using a stochastic weighted minimum mean square error (SWMMSE) algorithm to optimize a utility function in accordance with channel statistics of communications channels in a communications system;
adjusting, by the transmitting device, a transmitter of the transmitting device in accordance with the beamformer; and
transmitting, by the transmitting device, to a user equipment using the adjusted transmitter.

2. The method of claim 1, wherein the utility function comprises a weighted sum rate utility function.

3. The method of claim 1, wherein the utility function comprises one of a harmonic mean utility function and a proportional fairness utility function.

4. The method of claim 1, wherein designing the beamformer comprises:
determining channel estimates of a subset of the communications channels in the communications system;
deriving the channel statistics of the communications channels in the communications system in accordance with the channel estimates; and
determining the beamformer using the SWMMSE algorithm to optimize the utility function in accordance with the channel statistics.

5. The method of claim 4, wherein determining the beamformer comprises optimizing a stochastic performance of the user equipment.

6. The method of claim 4, wherein deriving the channel statistics comprises:
evaluating Uₖ←(ΣⱼHₖⱼ^{r}VⱼVⱼ^{H}(Hₖⱼ^{r})^{H}+σₖ²I)⁻¹Hₖₖ^{r}Vₖ,∀k;
evaluating Wₖ←(I−Uₖ^{H}Hₖₖ^{r}Vₖ)⁻¹Hₖₖ^{r}Vₖ,∀k;
evaluating Aₖ←Aₖ+Σⱼ₌₁^{K}(Hⱼₖ^{r})^{H}UⱼVⱼUⱼ^{H}Hⱼₖ^{r},∀k; and
evaluating Bₖ←Bₖ+(Hₖₖ^{r})^{H}UₖWₖ,∀k,
where Uₖ is a receiver postcoder for receiver k, Vₖ is a transmitter precoder for transmitter k, Wₖ is a weighting matrix of user k that relates a sum utility maximization to a sum mean square error (MSE) minimization, Aₖ and Bₖ are statistical information for a reciprocal communications channel, Hₖ is a channel matrix for a communications channel of user k, and σₖ is a noise distribution of a communications channel of user k.

7. The method of claim 6, wherein determining the beamformer comprises:
evaluating Vₖ←(Aₖ+μₖ*I)⁻¹Bₖ,∀k,
where μₖ* is an optimum Lagrange multiplier that is obtained using a one dimensional search algorithm.

8. The method of claim 6, further comprising applying a forgetting factor to Aₖ and Bₖ.

9. The method of claim 4, wherein determining the channel estimates, deriving the channel statistics, and determining the beamformer is repeated until a convergence criteria is met.

10. The method of claim 4, further comprising:
modeling channel estimates of a remainder of the communications channels; and
determining the beamformer in accordance with the modeled channel estimates.

11. The method of claim 1, further comprising:
receiving channel state information from the UE; and
deriving the channel statistics from the channel state information.

12. The method of claim 1, further comprising:
receiving channel state information for a subset of the communications channels in the communications system;
modeling channel estimates for a remainder of the communications channels in the communications system thereby producing modeled channel estimates; and
deriving the channel statistics from the channel state information and the modeled channel estimates.

13. The method of claim 1, further comprising:
estimating reciprocal channels of a subset of the communications channels in the communications system thereby producing estimated reciprocal channels; and
deriving the channel statistics from the estimated reciprocal channels.

14. The method of claim 1, further comprising:
estimating reciprocal channels of a subset of the communications channels in the communications system thereby producing estimated reciprocal channel;
modeling channel estimates for a remainder of the communications channels in the communications system thereby producing modeled channel estimates; and
deriving the channel statistics from the estimated reciprocal channel and the modeled channel estimates.

15. A method for operating a device, the method comprising:
determining, by the device, channel estimates of a subset of communications channels in a communications system;
deriving, by the device, statistical information of the communications channels in the communications system in accordance with the channel estimates; and
storing, by the device, the statistical information in a memory.

16. The method of claim 15, wherein the statistical information comprises information for reciprocal communications channels, and wherein deriving the statistical information comprises:
evaluating Aₖ←Aₖ+Σⱼ₌₁^{K}(Hⱼₖ^{r})^{H}UⱼVⱼUⱼ^{H}Hⱼₖ^{r},∀k; and
evaluating Bₖ←Bₖ+(Hₖₖ^{r})^{H}UₖWₖ,∀k,
where Uₖ is a receiver postcoder for receiver k, Vₖ is a transmitter precoder for transmitter k, Wₖ is a weighting matrix of user k that relates a sum utility maximization to a sum mean square error (MSE) minimization, Aₖ and Bₖ are statistical information for a reciprocal communications channel, Hₖ is a channel matrix for a communications channel of user k, and σₖ is a noise distribution of a communications channel of user k.

17. The method of claim 15, further comprising:
retrieving the statistical information from the memory; and
determining a beamformer using a stochastic weighted minimum mean square error algorithm to optimize a utility function in accordance with the statistical information.

18. A transmitting device comprising:
a processor configured to design a beamformer using a stochastic weighted minimum mean square error (SWMMSE) algorithm to optimize a utility function in accordance with channel statistics of communications channels in a communications system, and to adjust a transmitter of the transmitting device in accordance with the beamformer; and
the transmitter operatively coupled to the processor, the transmitter configured to transmit to a user equipment using the adjusted transmitter.

19. The transmitting device of claim 18, wherein the processor is configured to determine channel estimates of a subset of the communications channels in the communications system, to derive the channel statistics of the communications channels in the communications system in accordance with the channel estimates, and to determine the beamformer using the SWMMSE algorithm to optimize the utility function in accordance with the channel statistics.

20. The transmitting device of claim 19, wherein the processor is configured to evaluate Uₖ←(ΣⱼHₖⱼ^{r}VⱼVⱼ^{H}(Hₖⱼ^{r})^{H}+σₖ²I)⁻¹Hₖₖ^{r}Vₖ,∀k, to evaluate Wₖ←(I−Uₖ^{H}Hₖₖ^{r}Vₖ)⁻¹Hₖₖ^{r}Vₖ,∀k, to evaluate Aₖ←Aₖ+Σⱼ₌₁^{K}(Hⱼₖ^{r})^{H}UⱼVⱼUⱼ^{H}Hⱼₖ^{r},∀k, and to evaluate Bₖ←Bₖ+(Hₖₖ^{r})^{H}UₖWₖ, ∀k, where Uₖ is a receiver postcoder for receiver k, Vₖ is a transmitter precoder for transmitter k, Wₖ is a weighting matrix of user k that relates a sum utility maximization to a sum mean square error (MSE) minimization, Aₖ and Bₖ are statistical information for a reciprocal communications channel, Hₖ is a channel matrix for a communications channel of user k, and σₖ is a noise distribution of a communications channel of user k.

21. The transmitting device of claim 20, wherein the processor is configured to evaluate Vₖ←(Aₖ+μₖ*I)⁻¹Bₖ,∀k, where μₖ* is an optimum Lagrange multiplier that is obtained using a one dimensional search algorithm.

22. The transmitting device of claim 20, wherein the processor is configured to apply a forgetting factor to Aₖ and Bₖ.
